(19) United States
(12) Patent Application Publication
(10) Pub. No.: US 2005/0195712 A1
(43) Pub. Date: Sep. 8, 2005

(54) Disk recording control method and disk recording control device

(76) Inventor: Satoshi Banjo, Fukuoka (JP)

Correspondence Address: MCDERMOTT WILL & EMERY LLP, 600 13TH STREET, N.W., WASHINGTON, DC, 20005-3096, US

(21) Appl. No.: 11/065,348

(22) Filed: Feb. 25, 2005

(30) Foreign Application Priority Data
Feb. 25, 2004 (JP) P. 2004-049113

(51) Int. Cl. G11B 5/09

(52) U.S. Cl. 369/53.2

(57) ABSTRACT

Idle time recognizing means 104 recognizes a period of time when no access request is made for an optical disk medium 1, and when the period of time recognized by the idle time recognizing means 104 is equal to or longer than a set period of time, region soundness inspection processing means 103 recognizes a region on the optical disk medium 1 in which normal recording is possible and storing means 109 stores the information recognized by the region soundness inspection processing means 103.

### BACKGROUND OF THE INVENTION

1. Field of the Invention

The present invention relates to a disk recording control method and a disk recording control device for making a data recording by sectors in a track of a disk medium.

2. Description of the Related Art

(1) Defect Management Process at the Time of Optical Disk Recording

In a recording process of an optical disk medium, a standard for performing a defect management process at the time of recording is becoming more common in order to guard the recording data requested from a higher-level device even when failure of a recording operation due to a defect, such as a scratch or dirt, on the optical disk medium itself, the deterioration in recording quality or the like occurs.

In the defect management process, when an error occurs during a recording operation or when a verify operation of information after recording fails, performed is a process (replacement process) for allocating a partial region (post-replacement region) of a region for replacement recording prepared on the same disk to record recording data in a region (pre-replacement region), in which a failure occurs, into the partial region.

In the replacement process, when recording into the post-replacement region fails or when a verify operation after recording into the post-replacement region fails, another post-replacement region is further allocated to perform replacement recording again. At the same time, a process is performed so that information on replacement between a pre-replacement region and a post-replacement region is registered in a defect management list.

That is, an error termination of a recording process and a recording data disappearance are prevented by performing the replacement recording to another region even when a recording failure occurs. Moreover, when a request for accessing an address registered in the defect management list is made the next time, the request can be replaced by a request for accessing a corresponding post-replacement address according to the defect management list.

(2) Inspection Process of a Region on an Optical Disk Medium

In the optical disk medium recording associated with defect management explained in the above-described item (1), a delay may possibly occur for a data recording request or subsequent disk access requests due to the occurrence of a replacement process.

In order to avoid such a problem, a process (region soundness inspection process) for inspecting the presence of a scratch or dirt is performed for a recording region on an optical disk medium preliminarily before recording is started. (See the Japanese Unexamined Patent Publication No. 2001-256649. for example.)

A replacement process due to failure in a recording process can be prevented from occurring by preliminarily excluding a region in which the presence of a scratch or dirt has been confirmed from a region in which a recording is to be made, and allocating a replacement region.

(1) In a conventional method, regarding a process for inspecting the presence of a scratch or dirt to be performed for a recording region on an optical disk medium preliminarily before recording is started in order to avoid failure in a recording process, there are problems that it is necessary to issue a command for inspection from a higher-level device side in order to inspect a scratch or dirt and it is also necessary to change an application of the higher-level device in order to mount a soundness inspection process.

(2) A soundness inspection process for a region on an optical disk medium to be performed ahead of a recording process is often performed by irradiating the optical disk medium with a laser beam of an intensity of a regeneration level. In this case, it is difficult to decide a threshold of detection of a scratch or dirt since the inspection process is performed by a laser intensity different from the one used at the time of the recording process which is to be actually performed. Accordingly, there may arise a problem that an excessive replacement process is performed or a recording delay due to detection failure of a scratch or dirt occurs, depending on a method for deciding a threshold of detection of a scratch or dirt.

### SUMMARY OF THE INVENTION

The present invention is a disk recording co ntrol method for recording and reproducing data by sectors in/from a track provided with a concentric or spiral track, comprising: an idle time recognition step of recognizing a period of time when no access request is made for a disk medium; a region soundness inspection process step of discriminating a region on the disk medium in which normal recording is possible, when the period of time recognized in the idle time recognition step is equal to or longer than a set period of time; and a region soundness storage step of causing storing means to store information discriminated in the region soundness inspection process step. With this structure, a sector which is free from the possibility of a recording failure is allocated as a recording region using information stored in storing means on the result of a soundness inspection process performed before a recording process, so that data recording without a recording failure is enabled.

The present invention further comprises: a recording step of recording information on the disk medium; and a replacement step of allocating a replacement region as a recording position on the basis of recognition information stored in the storing means, when a recording position on a disk medium is discriminated during the recording step as a region in which normal recording is impossible. With this structure, data recording without failure can be performed effectively at a replacement region which is allocated when no access request is made for the disk medium.

In the present invention, when an access request is made for the disk medium during the region soundness inspection process step, the soundness inspection process step is interrupted in order to attend to the access request. With this structure, a delay for the command request associated with a disk access from a higher-level device can be reduced.

In the present invention, when an access request is made for the disk medium during the region soundness inspection process step, whether to interrupt the region soundness inspection process step or not is switched over depending on the remaining time before the region soundness inspection process step terminates. With this structure, when the remaining time is equal to or longer than a set period of time, interruption of a region soundness inspection process can be indicated while keeping the disk access request of a higher-level device from being delayed.

Moreover, the present invention is a disk recording control method for recording data by sectors in a track provided with a concentric or spiral track, comprising: an idle time recognition step of recognizing a period of time when no access request is made for a disk medium; a region soundness inspection process step of discriminating a region on the disk medium which has the possibility of a recording failure, when the period of time recognized in the idle time recognition step is equal to or longer than a set period of time; and a region soundness storage step of causing storing means to store information discriminated in the region soundness inspection process step. With this structure, a sector which is free from the possibility of a recording failure is allocated as a recording region using information stored in storing means on the result of a soundness inspection process which is performed before a recording process, so that data recording without a recording failure is enabled.

The present invention further comprises: a recording step of recording information on the disk medium; and a replacement step of allocating a replacement region as a recording position in ascending order of the possibility of a recording failure on the basis of recognition information stored in the storing means, when the recording position on the disk medium is recognized during the recording step as a region in which normal recording is impossible. With this structure, recording to a region which has a low possibility of a recording failure can be conducted according to the priority.

The present invention further comprises: a recording step of recording information on the disk medium; and a replacement step of allocating a replacement region as a recording position on the basis of the importance of information to be recorded and recognition information stored in the storing means, when a recording position on the optical disk medium is recognized during the recording step as a region in which normal recording is impossible. With this structure, allocation can be performed according to the definition of priority depending on the importance of information.

The present invention further comprises: a recording step of recording information on the disk medium; and a replacement step of allocating a replacement region as a recording position on the basis of elapsed time since a start of search of a new replacement region and recognition information stored in the storing means, when a recording position on an optical disk medium is recognized during the recording step as a region in which normal recording is impossible. With this structure, allocation can be performed according to the definition of the relation between soundness characteristics and region allocation priority.

The present invention further comprises: a recording step of recording information on the disk medium; and a replacement step of allocating a replacement as a recording position depending on a period of time from reception of an executable instruction of the recording step to execution of the recording step. With this structure, the possibility of a recording process failure or verify process failure can be further lowered.

The present invention further comprises: a recording step of recording information on the disk medium; and a replacement step of allocating a replacement region as a recording position on the basis of the degree of real-time characteristics of information to be recorded and recognition information stored in the storing means, when a recording position on the disk medium is recognized during the recording step as a region in which normal recording is impossible. With this structure, the space efficiency of the disk medium can be enhanced by allocating a recording region having soundness characteristics corresponding to the degree of real-time characteristics.

In the present invention, the storing means for storing information in the region soundness storage step is the optical disk medium. With this structure, the data recognized in the region soundness inspection process step can be read and written at high speed without using an external memory.

The present invention comprises a storage step of storing in nonvolatile storing means soundness information read in the region soundness inspection process step and ID information for identifying an optical disk medium from which soundness is read. With this structure, the optical disk medium information can be managed on the nonvolatile storing means by ID information.

Moreover, the present invention is a disk recording control device for recording data by sectors in a track provided with a concentric or spiral track, comprising: idle time recognizing means for recognizing a period of time when no access request is made for a disk medium; region soundness inspection processing means for discriminating a region on the disk medium in which normal recording is possible, when the period of time recognized by the idle time recognizing means is equal to or longer than a set period of time; and storing means for storing information discriminated by the region soundness inspection processing means. With this structure, when a period of time when no access is made for the disk medium is equal to or longer than a set period of time, a region in which normal recording is possible is recognized and a sector which is free from the possibility of a recording failure is allocated as a recording region using the recognition information, so that data recording without recording failure is enabled.

Moreover, the present invention is a disk recording control device for recording data by sectors in a track provided with a concentric or spiral track, comprising: idle time recognizing means for recognizing a period of time when no access request is made for a disk medium; region soundness inspection processing means for discriminating a region on the disk medium which has the possibility of a recording failure, when the period of time recognized by the idle time recognizing means is equal to or longer than a set period of time; and region soundness storing means for causing storing means to store information discriminated by the region soundness inspection processing means. With this structure, when a period of time when no access request is made is equal to or longer than a set period of time, a sector which is free from the possibility of a recording failure is allocated as a recording region using the information which is stored before a recording process, by recognizing the possibility of recording failure of each region on the disk medium and storing the recognized information in the storing means, so that data recording without recording failure is enabled.

Moreover, the present invention is an optical disk medium, in which information can be recorded, comprising information on the possibility of a recording failure of each recording region of its own. With this structure, the information on the possibility of a recording failure recognized in the region soundness inspection process step can be read and written at high speed without using an outer memory.

With the present invention, even when there is a scratch or dirt in a recording region on an optical disk medium, the possibility of a recording failure can be decreased and effective defect management recording can be performed by preliminarily inspecting dirt before recording and by referring to the inspection result at the time of recording region allocation. Moreover, an inspection process for a scratch of dirt in a recording region can be performed without delaying a request from a higher-level device. Furthermore, a control for enhancing the space efficiency of the optical disk medium is possible by performing recording region allocation depending on the type of the recording data, such as a record of AV data for which real-time characteristics are required or data recording for which low real-time characteristics are required.

### BRIEF DESCRIPTION OF THE DRAWINGS

FIG. 1 is a block diagram of an optical disk recording control device according to an embodiment of the present invention.

FIG. 2 is an explanatory view of the structure of an optical disk medium according to an embodiment of the present invention.

FIG. 3 is a flowchart of the defect management recording process procedure according to an embodiment of the present invention.

FIG. 4 is a flowchart of the idle time recognition process procedure according to an embodiment of the present invention.

FIG. 5 is a flowchart of the command process procedure according to Embodiment 1 of the present invention.

FIG. 6 is a flowchart of the control process procedure of an optical disk recording control device according to Embodiment 1 of the present invention.

FIG. 7 is a flowchart of the command process procedure according to Embodiment 2 of the present invention.

FIG. 8 is a flowchart of the region soundness inspection process procedure according to Embodiment 2 of the present invention.

FIG. 9 is an explanatory view of a structure of region soundness inspection result information according to an embodiment of the present invention.

FIG. 10 is an explanatory view of another structure of region soundness inspection result information according to an embodiment of the present invention.

FIG. 11 is a flowchart of the defect management recording process procedure according to an embodiment of the present invention.

FIG. 12 is an explanatory view of region allocation priority definition according to Embodiments 1 and 2 of the present invention.

FIG. 13 is an explanatory view of region allocation priority definition according to Embodiment 3 of the present invention.

FIG. 14 is an explanatory view of region allocation priority definition according to Embodiment 4 of the present invention.

FIG. 15 is an explanatory view of a region soundness inspection result according to Embodiments 1 and 2 of the present invention.

FIG. 16 is an explanatory view of a region allocation process operation according to Embodiments 1 and 2 of the present invention.

FIG. 17 is a flowchart of the initialization process procedure of region soundness inspection result information according to Embodiments 1 to 4 of the present invention.

FIG. 18 is a flowchart of the recording process procedure of region soundness inspection result information according to Embodiment 5 of the present invention.

FIG. 19 is a flowchart of the initialization process procedure of region soundness inspection result information according to Embodiment 5 of the present invention.

FIG. 20 is a flowchart of the recording process procedure of region soundness inspection result information according to Embodiment 6 of the present invention.

FIG. 21 is a flowchart of the initialization process procedure of region soundness inspection result information according to Embodiment 6 of the present invention.

### DESCRIPTION OF THE PREFERRED EMBODIMENTS

### Embodiment 1

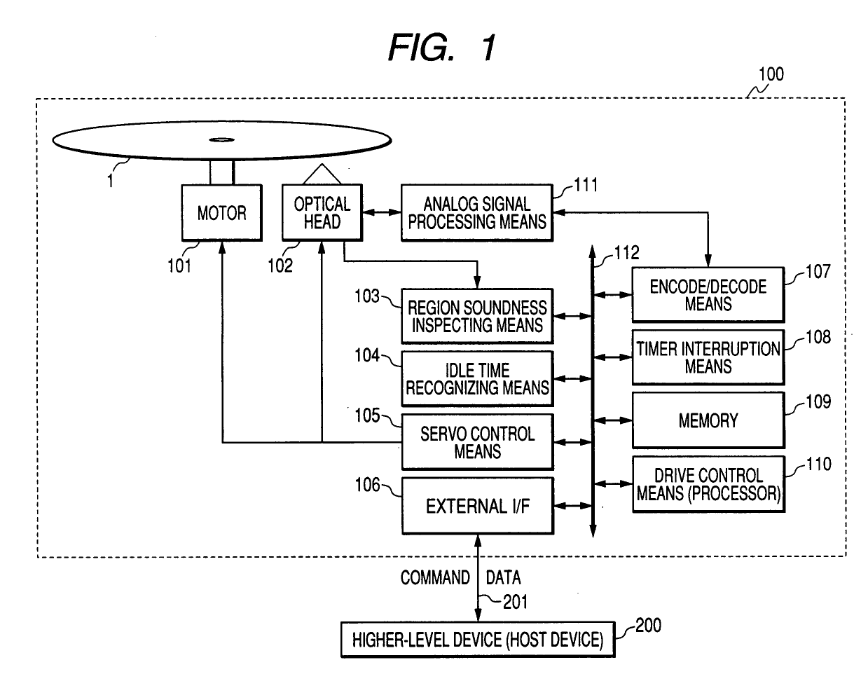

FIG. 1 is a block diagram showing an embodiment of an optical disk recording control device composed of a disk recording reproduction device and a higher-level device. An optical disk recording control device in FIG. 1 is composed of a higher-level device (host device) 200 and an optical disk recording reproduction device 100 for recording and reproducing for an optical disk medium 1.

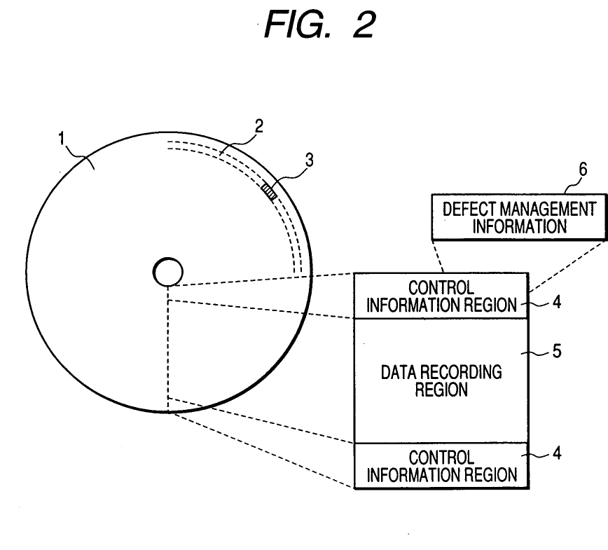

FIG. 2 is an explanatory view of the structure of the optical disk medium 1. The plate-shaped optical disk medium 1 is provided with a concentric or spiral track 2 and each track 2 is provided with a subdivided sector 3. All sectors are provided with absolute addresses which are referred to as physical sector addresses.

The optical disk medium 1 is also provided with a control information region 4 and a data recording region 5, wherein recording and reproducing of data are performed for the data recording region 5.

Defect management information 6 is recorded in a portion of the control information region 4. In the defect management information 6, replacement information of addresses of a defect sector and a replacement sector are recorded as data structure in list form.

The higher-level device 200 is connected with the optical disk recording reproduction device 100 via an I/O bus 201. The I/O bus 201 is a general-purpose bus including the SCSI (Small Computer System Interface), the ATA (AT Attachment), the USB (Universal Serial Bus) and the IEEE 1394.

The optical disk recording reproduction device 100 is composed of a motor 101, an optical head 102, region soundness inspecting means 103, idle time recognizing means 104, servo control means 105, an outer I/F 106, encode/decode means 107, timer interruption means 108, a memory 109, drive control means 110, analog signal processing means 111 and a bus 112.

In the optical disk recording reproduction device 100, the motor 101 is designed to rotate and stop the optical disk medium 1, and operates at the time of accessing the optical disk medium 1.

The optical head 102 is designed to record and reproduce information in and from the optical disk medium 1 and is composed of a laser device and a lens.

The analog signal processing means 111 modulates digital data inputted from the encode/decode means 107 into an analog signal and outputs the analog signal to the optical head 102. The analog signal processing means 111 also demodulates an analog signal inputted from the optical head 102 into a digital bit string and outputs the digital data to the encode/decode means 107.

The servo control means 105 controls the motor 101 and the optical head 102 with respect to the optical disk medium 1 so as to access a target position of the optical disk medium 1 on the basis of a signal which is obtained as reflected light when emitting a laser beam from the optical head 102.

The encode/decode means 107 performs a conversion process, such as coding, decoding, scrambling and descrambling, for a data row inputted from the analog signal processing means 103 or the memory 109, and outputs a data row obtained as the result respectively to the memory 109 or the analog signal processing means 111.

The region soundness inspecting means 103 inspects the degree of scratches or dirt on the recording surface of the optical disk medium 1 on the basis of the result of the operation performed by the encode/decode means 107 or the analog signal inputted from the optical head 102 to the analog signal processing means 111, and stores the inspection result in the memory 109.

The memory 109 has a region which is to be used as an intermediate buffer at the time of recording and reproducing of data, a region for an operation process to be performed by the encode/decode means 107, a region for temporarily storing the inspection result obtained by the region soundness inspecting means 103 and the like, and is used for overall data processes in the optical disk recording reproduction device 100. Though FIG. 1 shows the memory 109 as a single unit, the memory 109 may be divided by objectives or may be incorporated in each control means. The memory 109 may also be either a nonvolatile memory or a volatile memory.

The idle time recognizing means 104 gives notice to the drive control means 110 when it is detected that no request associated with an access to the optical disk medium 1 in a command issued from the higher-level device 200 to the optical disk recording reproduction device 100 is made for more than a certain period of time.

The drive control means 110 is connected respectively with the region soundness inspecting means 103, the idle time recognizing means 104, the servo control means 105, the outer I/F 106, the encode/decode means 107, the timer interruption means 108 and the memory 109 via the bus 112, and controls the entire optical disk recording reproduction device 100 by giving instructions to the respective units 103 to 109. The operation software thereof is stored in the memory 109.

The outer interface 106, which is connected with the bus 112, accepts a command from the outside to the optical disk recording reproduction device 100 via the I/O bus 201, outputs a status, and inputs and outputs data.

The timer interruption means 108 detects that a given period of time specified by the drive control means 110 has elapsed and gives notice to the drive control means 110.

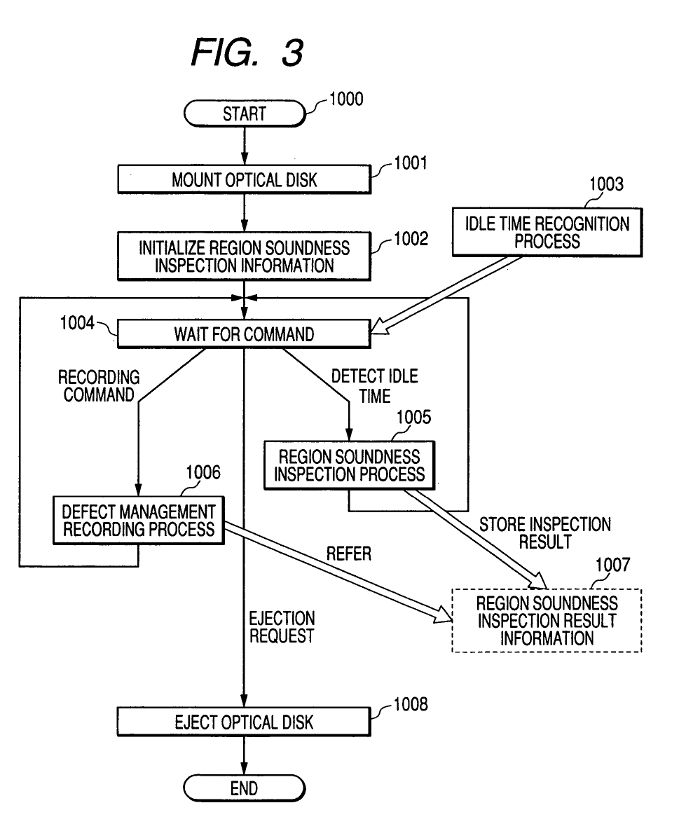

Regarding the information processing system constructed as described above, the flow of a defect management recording process according to the present invention is shown in FIG. 3. It should be noted that command processes other than a recording request are omitted in FIG. 3 for the sake of convenience.

After the optical disk medium 1 is mounted (step S1001), the optical disk recording reproduction device 100 initializes information on the result of inspection on scratches or dirt on the recording surface of an optical disk medium 1 which has been performed by the region soundness inspecting means 103 (step S1002). In response to reception of a recording command issued from a higher-level device (step S1004), the optical disk recording reproduction device 100 performs a defect management recording process (step S1006).

When an idle time is detected in an idle time recognition process by the idle time recognizing means 104 (step S1003) while waiting for reception of a recording command, the region soundness inspection processing means 103 performs a soundness inspection process for the data recording region 5 of the optical disk medium 1 (step S1005). The inspection result of this inspection process is stored in the memory (storing means) 109 as region soundness inspection information (step S1007) and is referred to at the time of a defect management recording process (step S1006). This region soundness inspection information is initialized after mounting a disk (step S1002).

The following description will explain the idle time recognition process (step S1003), the region soundness inspection process (step S1005) and the defect management recording process (step S1006) to be performed in FIG. 3 in detail.

(1) Idle Time Recognition Process

The following description will explain a process for detecting by the idle time recognizing means 104 that no request associated with an access to the optical disk medium 1 in a command issued from the higher-level device 200 to the optical disk recording reproduction device 100 is made for more than a certain period of time and indicating a start of a region soundness inspection process.

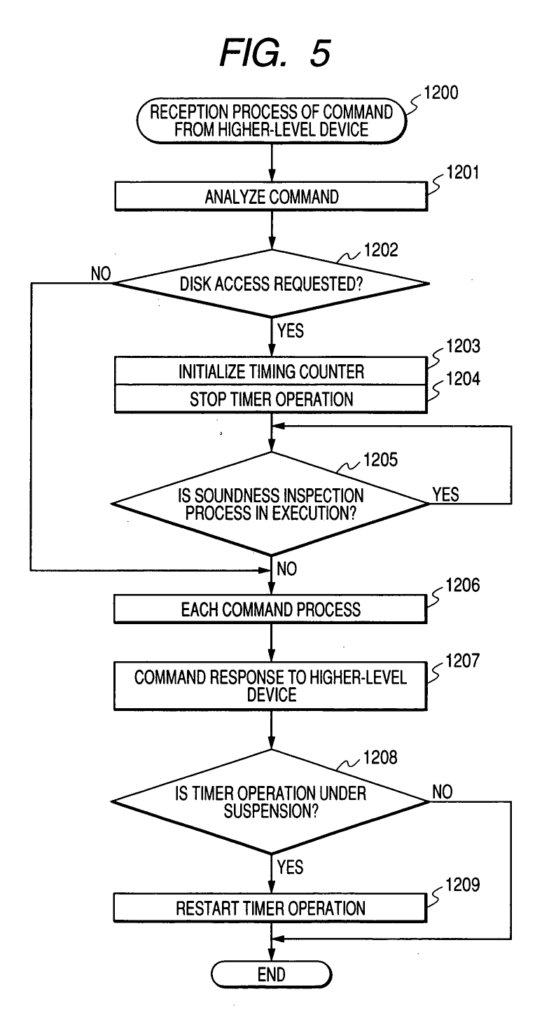

FIG. 5 is a flowchart of a process (step S1200) which is to be performed when a command from the higher-level device is received.

After receiving a command, the command is analyzed (step S1201), and when there is no access request for the optical disk medium 1 (step S1202), a process corresponding to each command is performed (step S1206). Upon receiving a command associated with a disk access request when the region soundness process is in execution, a command process is performed (step S1206) after the region soundness process terminates. After termination of the command process, the result is sent back to the higher-level device (step S1207).

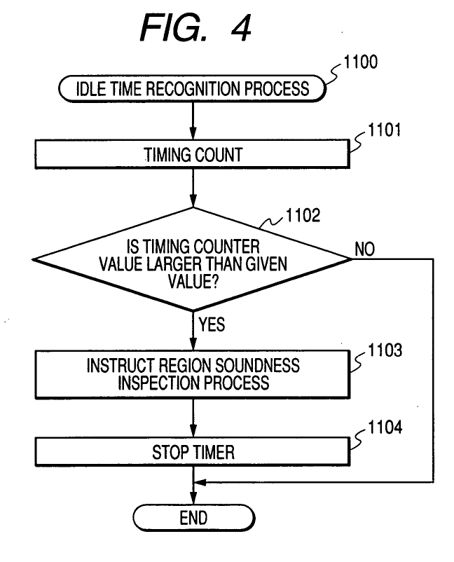

FIG. 4 is a flowchart showing the flow of a process for detecting the idle time and indicating a start of the region soundness inspection process.

The process shown in FIG. 4 is performed at constant time intervals utilizing timer interruption. A timing counter is counted up for each process (step S101), judged is whether the timing counter value exceeds a fixed value or not (step S1102), and when this counter value is equal to or larger than a fixed value, a start of the region soundness inspection process is indicated (step S1103) and a timer operation is stopped (step S1104).

The initialization of the timing counter value and the timer operation starting process are performed immediately after mounting the optical disk medium. Every time a disk access request command from the higher-level device is received, the counter is initialized and the timer operation is stopped (steps S1203, S1204). The stopped timer operation is restarted after a response to the disk access request command is completed (steps S1208, S1209).

An idle time when no request associated with a disk access in a command from the higher-level device is generated for more than a certain period of time is detected in the control mentioned above, and when this idle time is detected, a start of the region soundness inspection process is indicated. The duration to be used as the criterion for detecting the idle time is preliminarily set as a given value.

(2) Region Soundness Inspection Process

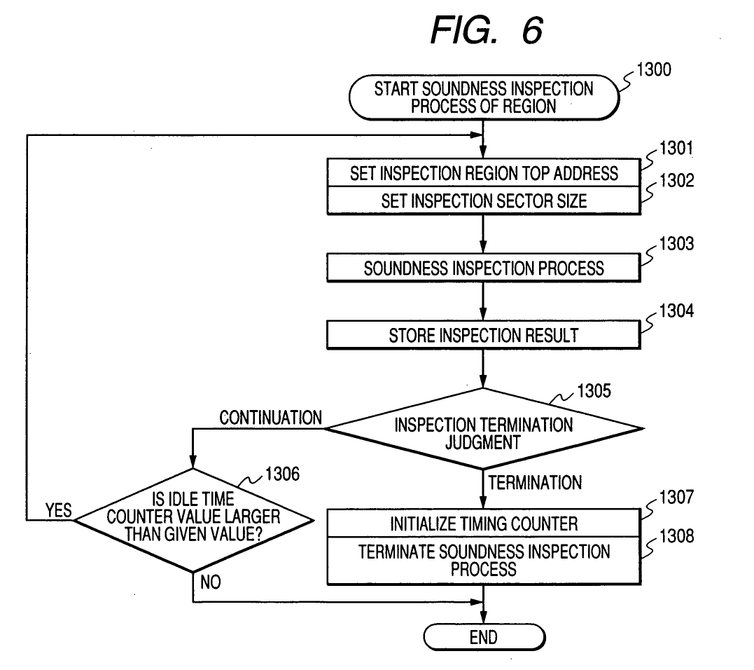

FIG. 6 is a flowchart showing the flow of the region soundness inspection process (step S1300).

In the process shown in FIG. 6, an address located at the top of an inspection region is first set (step S1301) and the sector size to be inspected is further set (step S1302).

An indication is given to the servo control means 105, and the motor 101 and the optical head 102 are controlled to access a region position on the optical disk medium which is to be inspected.

When the optical head 102 provides this access, the region soundness inspection (step S1303) is performed. It should be supposed that the value of the soundness inspection result information obtained as the measurement result of inspection is a value correlating with the possibility of a recording process failure for a region to be inspected and can be represented as a graduated value.

The following are suggested soundness inspection methods for obtaining the soundness inspection result.

(a) To calculate a value of the soundness inspection result from the reflectance of the reflected light which is obtained when the optical head 102 irradiates the region to be inspected with a laser beam.

For example, allocated is a value by which it is judged from the soundness inspection result of the area that the possibility of a recording failure is higher as the reflectance is lower.

(b) To calculate a value of the soundness inspection result from the amplitude of the servo signal which is obtained when the optical head 102 irradiates the region to be inspected with a laser beam.

For example, allocated is a value by which it is judged from the soundness inspection result of the area that the possibility of a recording failure is higher as the average or the maximum value of the amplitude of the servo signal is larger.

(c) To calculate a value of the soundness inspection result from error detection/correction result information which is performed by the encode/decode means when a reproduction operation is performed for the region to be inspected.

For example, allocated is a value by which it is judged from the soundness inspection result of the area that the possibility of a recording failure is higher as the number of error detection/correction times is larger.

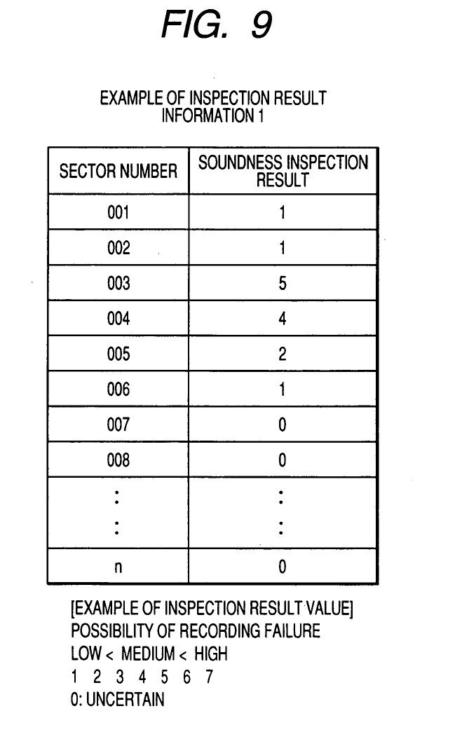

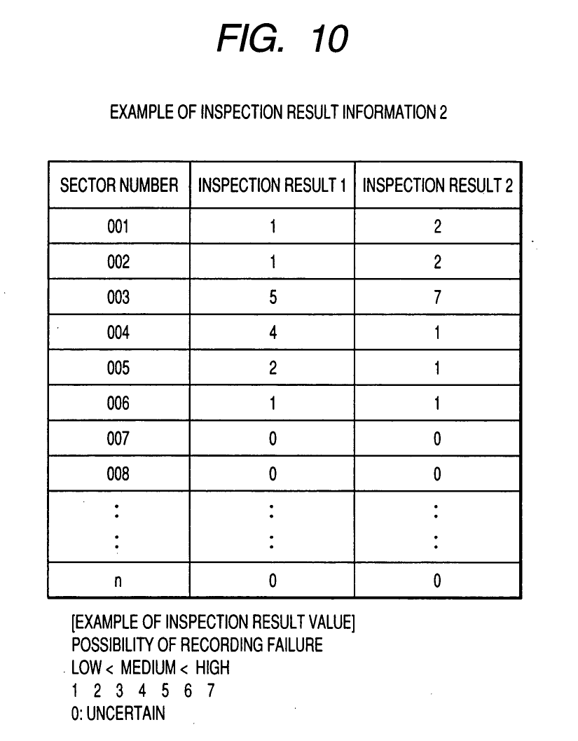

The value of the soundness inspection result obtained by the methods mentioned above is stored in the memory 109 as soundness inspection result information (1007 in FIG. 3) (step S1304). Examples of the format of the soundness inspection result information are shown in FIGS. 9 and 10.

In the examples shown in FIGS. 9 and 10, the soundness inspection result information is stored as a value of one of eight levels from 0 to 7, wherein the value 0 means the soundness remains unknown and the values from 1 to 7 mean that the possibility of a recording failure is higher as the value is larger. Though the soundness inspection result information is represented using values of eight levels in this example, values of levels other than eight levels may be used.

FIG. 10 is an example wherein the result of the region soundness inspection process performed by two types of inspection methods is stored for the region to be inspected. Like this, inspection may be performed by two or more types of methods and a plurality of soundness inspection result information may be stored for the same region.

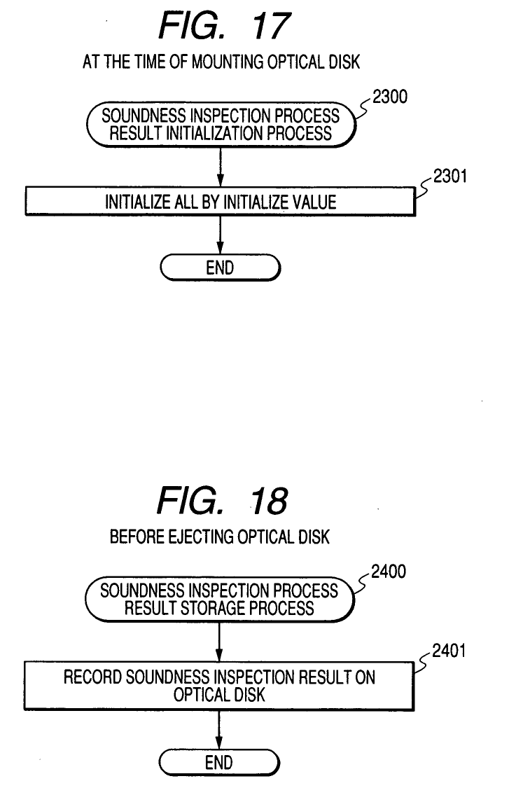

FIG. 17 is a flowchart showing an initialization process (2300) of the region soundness inspection result information. The region soundness inspection result information is initialized immediately after mounting a disk, using a predetermined initial value (step S2301).

Returning to FIG. 6, when a soundness inspection process for an inspection sector size set in the first step (step S1302) of the region soundness process terminates, whether there is a region to be inspected or not is judged (step S1305), and when no further inspection is necessary, the timing counter value to be used for the idle time detection judgment is initialized (step S1307). From then on, it is controlled not to perform a region soundness inspection process for the optical disk medium 1 which is currently mounted (step S1308). In a case where any inspection is still necessary, when it is judged that the counter value of idle time is smaller than a set value (set period of time) (step S1306), processes after the step S1301 are performed while when it is judged that the counter value of idle time is equal to or larger than a set value, the soundness inspection process terminates.

It should be noted that though a command process is not performed until the region soundness inspection process terminates in the example of a process to be performed upon receiving a command from a higher-level device explained using FIG. 5 in a case where the region soundness inspection process is in execution when a request associated with a disk access from the higher-level device is received (step S1205), the delay of the command process associated with the disk access request can be decreased by setting the inspection sector size set at the first step S1302 of the region soundness process small.

(3) Defect Management Recording Process

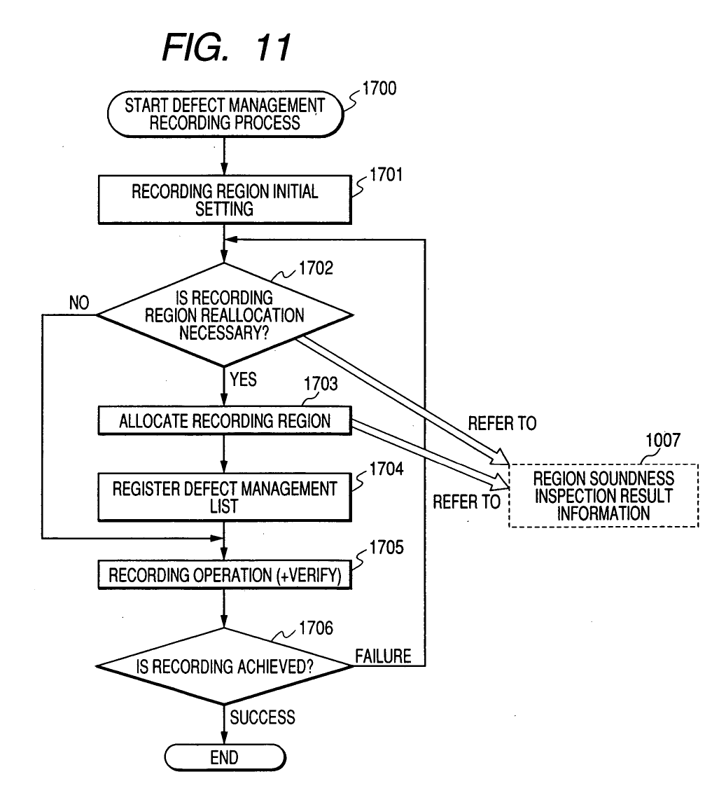

FIG. 11 is a flowchart showing the flow of a recording process associated with defect management.

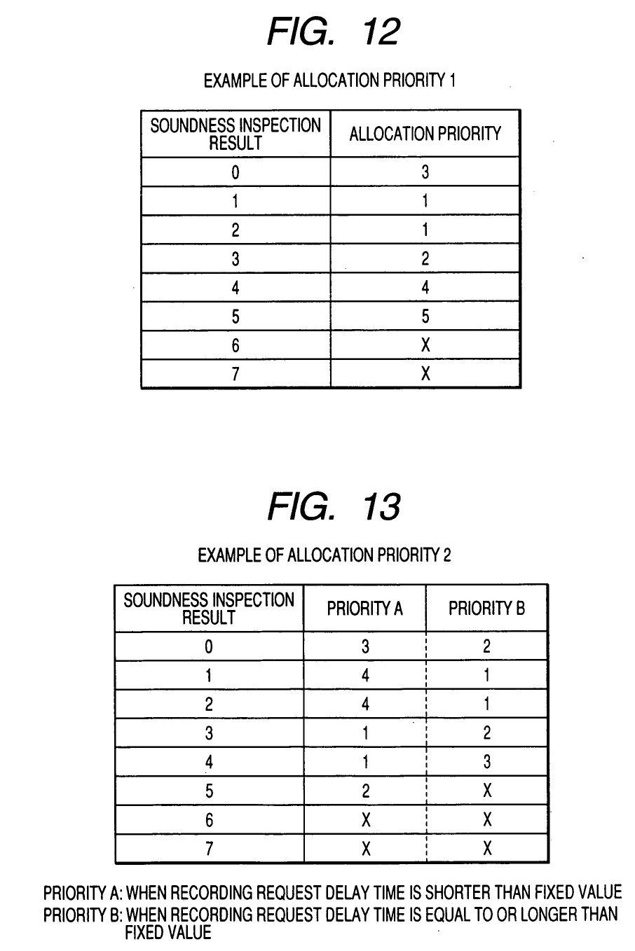

FIG. 12 is a view for defining the relation between the soundness result and the region allocation priority, which becomes the criterion for judging whether it is necessary to reallocate a recording region during the defect management recording process or not, for selecting a region to be reallocated, or the like, for a case where the soundness result information example having values of eight levels is employed as explained using FIG. 9.

The definition of priority shown in FIG. 12 is made so that higher priority is attached to a region having a lower possibility of a recording failure.

According to the priority defined in FIG. 12, regarding the values of soundness result information of eight levels of 0 to 7, the priority for allocating a region has a relation of priority height of “value 1”=“value 2”>“value 3”>“value 0”>“value 4”>value 5.” The “x” mark defined for the priority of “value 6” and “value 7” in FIG. 12 means exclusion from candidates of a region to be allocated.

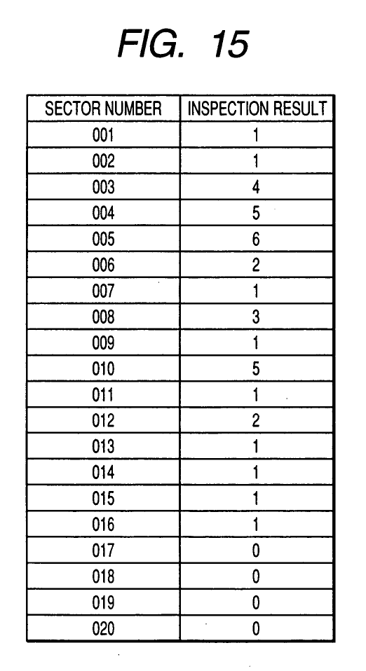

FIG. 15 is an explanatory view showing the state of the soundness inspection result of a region ranging from a sector number 001 to 020 of an optical disk medium 1 at the time of recording. The value of the soundness inspection result in FIG. 15 is any one of values of eight levels from 0 to 7 which are explained in FIG. 9. That is, regarding the inspection result values 1 to 7 shown in FIG. 15, a region having a larger value of soundness inspection result is a region having a higher possibility of a recording failure.

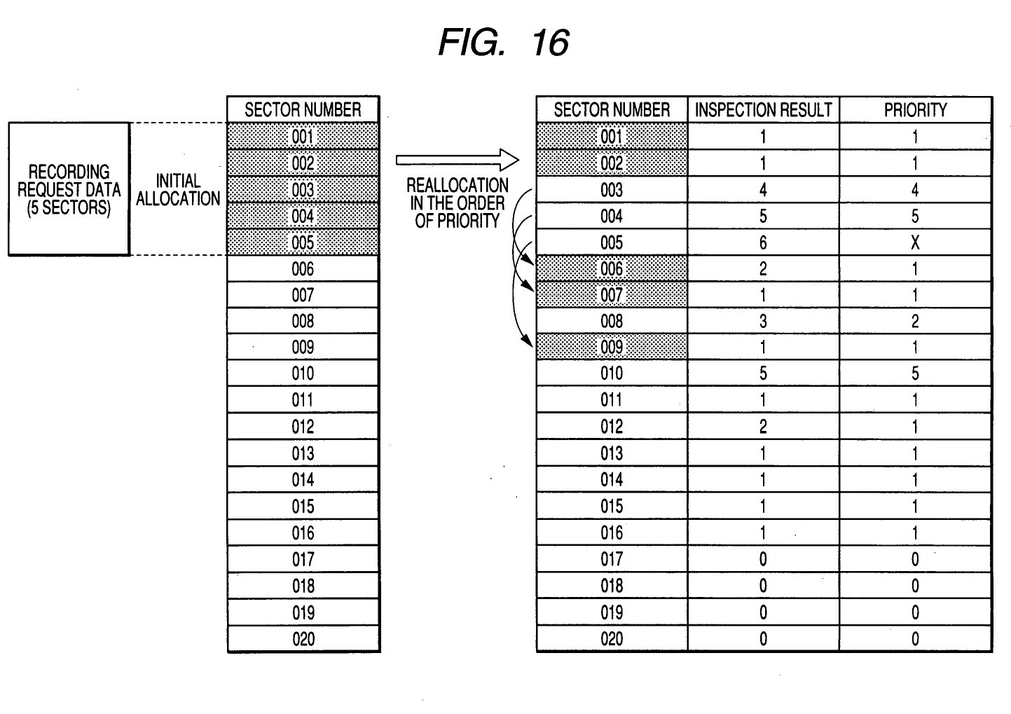

FIG. 16 is an explanatory view for showing an example in which initial recording region allocation in response to a request from a higher-level device for recording data of 5 sectors and reallocation of a recording region in the order of priority in FIG. 12 are performed for a recording region on the optical disk medium 1 shown in FIG. 15.

The following description will explain a region allocation process shown in FIG. 16 along the defect management recording process (1700) procedure shown in the flowchart in FIG. 11.

First, as a recording region initialization process (step S1701), on what address position of the optical disk medium 1 the recording data received with a recording request from the higher-level device is to be recorded is allocated (step S1701). As shown in FIG. 16, data of five sectors for which a recording request has been made is allocated to the sector numbers 001 to 005 as initialization allocation.

Next, whether reallocation of a recording region is necessary or not is judged (step S1702), referring to the region soundness inspection result information on an allocated recording region. When there is another region having soundness result information of higher priority with respect to the soundness inspection result information of the region allocated at the time point, reallocation is performed (step S1703) and replacement information of the region is registered as a defect management list (step S1704).

In the state of a recording region shown in FIG. 15, the soundness inspection result of the sector numbers 003, 004 and 005 are respectively 4, 5 and 6, and it is supposed that the possibility of a recording process failure in this area is high. Referring to the priority in FIG. 12, the priority of the sector numbers 003, 004 and 005 is respectively 4, 5 and x (see FIG. 16). Since sectors of higher priority are included in the sectors after the sector number 006, it can be judged in the judgment process (step S1702) that reallocation of a region is necessary.

In the example shown in FIG. 16, as the reallocation in the step S1703, the sector number 003 is reallocated to a sector number 006; the sector number 004 is reallocated to a sector number 007; and the sector number 005 is reallocated to a sector number 009.

After that, a recording operation is performed for an allocated region (step S1705). This recording process may include the verify operation according to need.

If recording failure or verify failure occurs in the process of the step S1705, the process returns to the step S1706 or S1702 to reallocate a recording region and record the same data again in another region (replacement process).

In reallocation of a recording region in the replacement process, the allocation destination is selected on the basis of judgment according to the priority defined in FIG. 12.

The recording operation associated with the replacement process is repeatedly performed until recording of all recording request data is achieved.

As described above, by referring to the soundness inspection result information obtained by the soundness inspection process performed during idle time in recording region allocation and allocating a region having a low possibility of a recording failure preferentially, the possibility of a recording process failure and verify process failure during data recording can be decreased.

### Embodiment 2

An optical disk recording control device according to Embodiment 2 is the same as Embodiment 1 in construction and the operations thereof are also the same as those of Embodiment 1.

The flow of a defect management recording process in Embodiment 2 is the same as that explained using FIG. 3 in Embodiment 1, and processes of (1) the idle time recognition process (step S1003) and (3) the defect management recording process (step S1006) are respectively the same as those explained in Embodiment 1.

(2) Region Soundness Inspection Process

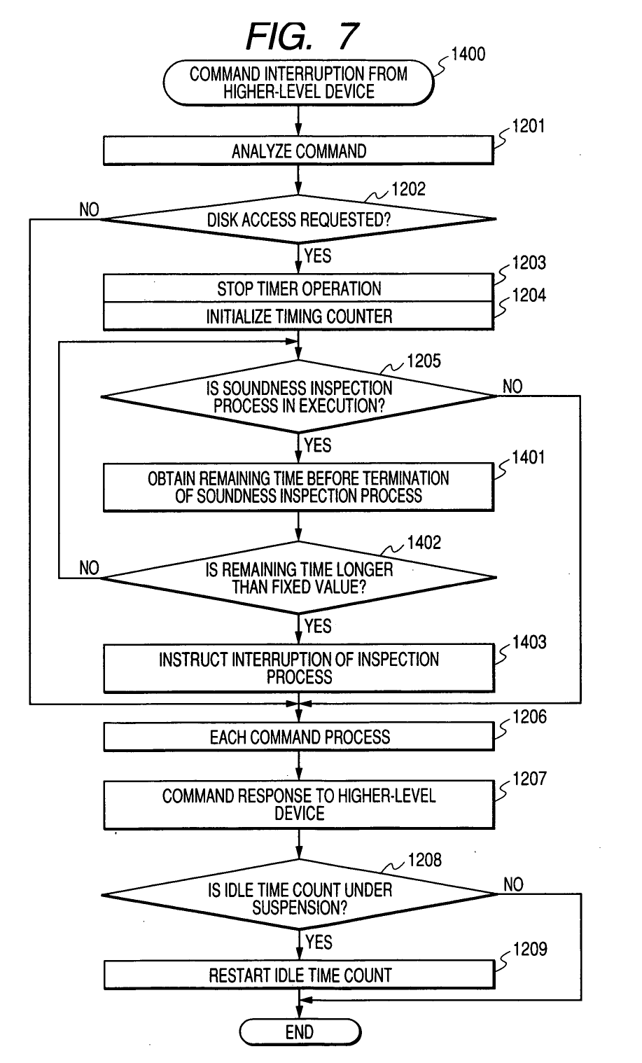

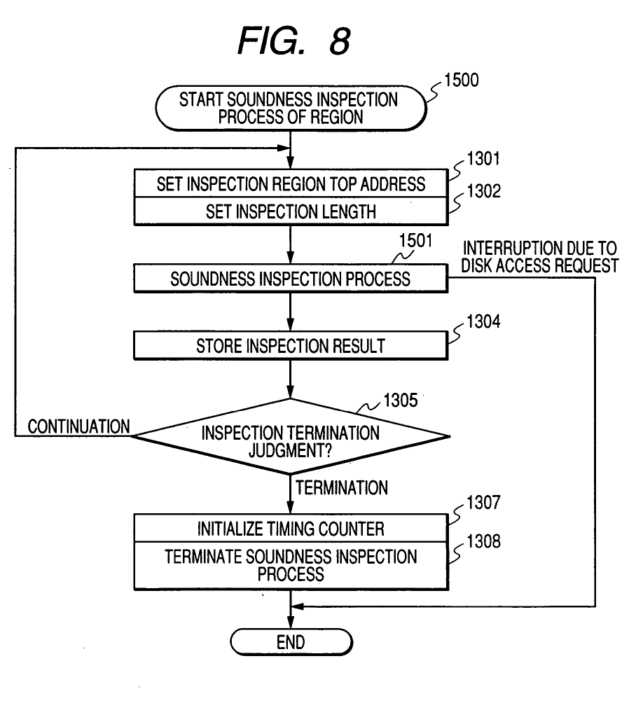

A region soundness inspection process (step S1005) in Embodiment 2 will be explained using FIGS. 7 and 8.

FIG. 7 is a flowchart showing the command interruption process (1400) procedure to be performed upon receiving a command from a higher-level device.

FIG. 8 is a flowchart showing the region soundness inspection process (1500) procedure in Embodiment 2.

Regarding FIG. 7, upon receiving a command, the command is analyzed (step S1201), and when no request of a disk access is made (step S1202), processes corresponding to each command are performed (step S1206).

When a disk access request is made and a command is received, the initialization of a timing counter upon receiving the command associated with the disk access request (step S1203), timer operation stop process (step S1204) and judgment (step S1205) of whether the region soundness process is in execution or not are performed in the same manner as those explained using FIG. 5 in Embodiment 1.

Similarly, the process for each command (step S1206), the process for responding to the higher-level device after termination of the command process (step S1207) and the idle time count restart process (steps S1208, S1209) in FIG. 7 are the same as those explained using FIG. 5 in Embodiment 1.

On the other hand, when it is judged in the judgment of the step S1205 that the region soundness inspection process is in execution, the remaining time before the termination of the region soundness inspection process in execution is derived and obtained (step S1401).

Whether this remaining time is longer than a given value or not is judged (step S1402), and when the remaining time is equal to or longer than a given value, an indication for immediately interrupting the region soundness inspection process is made in order not to delay the disk access request of the higher-level device (step S1403).

It should be noted that the judgment of the (step S1402) may be omitted and the interruption process (step S1403) may be performed without reservation.

In the region soundness inspection process (step S1501 in FIG. 8), when it is recognized that an interruption indication has been made (step S1403 in FIG. 7), the region soundness inspection process terminates immediately whether an inspection process of a sector size set in a process (step S1302) before the region soundness inspection process is completed or not.

Regarding FIG. 8, those other than the region heath inspection process (step S1501) are the same as those explained using FIG. 6 in Embodiment 1.

In the region soundness inspection process (step S1501), a control for recognizing the interruption indication (1403 in FIG. 7) in the course of a process and terminating the process immediately is added in comparison with the region soundness inspection process (step S1303) in FIG. 6.

By the control mentioned above, the delay for the command request associated with a disk access from the higher-level device can be reduced.

### Embodiment 3

An optical disk recording control device according to Embodiment 3 is the same as Embodiment 1 in construction and the operations thereof are also the same as those of Embodiment 1.

The flow of a defect management recording process in Embodiment 3 is the same as that explained using the defect management recording process in FIG. 3 in Embodiment 1, and (1) the idle time recognition process and (2) the region soundness inspection process are the same as processes (steps S1003, S1005) explained in Embodiment 1 or 2.

(3) Defect Management Recording Process

The flow of the defect management recording process (step S1006) in Embodiment 4 is the same as that explained using FIG. 11 in Embodiment 1.

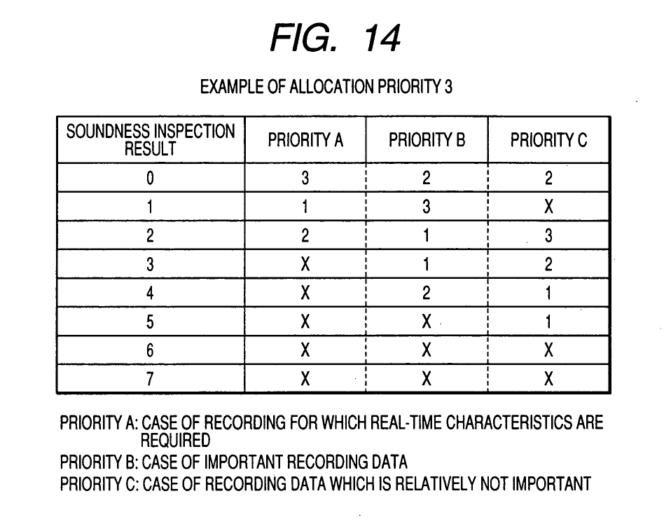

In Embodiment 4, when making judgment of recording region allocation referring to the region soundness inspection result information (step S1007) from the processes of the steps S1702 and S1703, definition of the relation between the soundness inspection result and the region allocation priority as shown in FIG. 14 (instead of FIG. 12 in Embodiment 1) is used.

In the definition of priority shown in FIG. 13, the priority is designed to be changed according to the delay time of the recording request from the higher-level device at the time of the priority judgment.

When the delay time is shorter than a fixed value, higher priority is attached to a region having a higher possibility of a recording failure while when the delay time is equal to or longer than a fixed value, higher priority is attached to a region having a lower possibility of a recording failure.

According to the priority defined in FIG. 13, performed is a control so as to allocate a region having relatively low soundness as a recording region and attempt recording when the delay time is short, so that the space efficiency of a disk can be enhanced.

Since a region having a low possibility of a recording failure is allocated when the delay time becomes long after repeatedly performing the replacement process, an effect of preventing a recording error due to timeout is also provided.

Though the definition is switched over between two divisions in FIG. 13, i.e. according to whether the delay time is shorter than a fixed value or not, the definition may be switched over among three or more divisions. It is necessary to preset the period of time to be used as the criterion for dividing the divisions.

### Embodiment 4

An optical disk recording control device according to Embodiment 4 is the same as Embodiment 1 in construction and the operations thereof are also the same as those of Embodiment 1.

The flow of a defect management recording process in Embodiment 4 is the same as that explained using the defect management recording process (step S1006) of FIG. 3 in Embodiment 1, and (1) the idle time recognition process and (2) the region soundness inspection process are the same as the respective processes (steps S1003, S1005) explained in Embodiment 1 or 2.

(3) Defect Management Recording Process

The flow of the defect management recording process (step S1006) in Embodiment 4 is the same as that explained using FIG. 11 in Embodiment 1.

In Embodiment 4, for making judgment of recording region allocation referring to the region soundness inspection result information (1007) from the process of the steps S1702 and S1703, definition of the relation between the soundness result and the region allocation priority as shown in FIG. 14 (instead of FIG. 12 in Embodiment 1) is used.

In the definition of priority shown in FIG. 14, the priority is designed to be changed according to the importance of data to be recorded and the real-time characteristics to be required for the recording process for recording region allocation. The following description will explain the definition shown in FIG. 14.

(Priority A)

This priority definition is enabled in a case of recording for which real-time characteristics are required. Only regions having the lowest possibility of a recording failure (regions having “value 1” or “value 2” of inspection result) are allocated preferentially.

(Priority B)

This priority definition is enabled when real-time characteristics are not required for recording but the data is important. Though regions having low priorities of a recording failure are allocated, regions having the lowest possibility of a recording failure (regions having “value 1” of inspection result) are set at low allocation priority in order to be reserved for a case where the recording region allocation by the (Priority A) occurs.

(Priority C)

This priority definition is enabled when real-time characteristics are not required for recording and the data is relatively not important. Regions having relatively high possibilities of a recording failure are allocated preferentially.

Note that regions having low possibilities of a recording failure (regions having “value 1” of inspection result) are controlled not to be allocated in order to be reserved for a case where the recording region allocation by the (Priority A) or (Priority B) occurs.

According to the priority defined in FIG. 14, performed is a control so as to allocate a region having soundness corresponding to the importance of recording data and real-time characteristics required for the recording process as a recording region in order to make a recording, so that the space efficiency of a disk can be enhanced.

Though the definition is switched over among three divisions according to the type of recording in the example shown in FIG. 14, the definition may be switched over among divisions other than the three divisions.

### Embodiment 5

An optical disk recording control device according to Embodiment 5 is the same as Embodiment 1 in construction and the operations thereof are also the same as those of Embodiment 1.

The flow of a defect management recording process in Embodiment 5 is the same as that explained using FIG. 3 in Embodiment 1, and the processes of (1) the idle time recognition process and (3) the defect management recording process are the same as the respective processes (steps S1003, S1006) respectively explained in Embodiment 1.

(2) Region Soundness Inspection Process

The flow of the region soundness inspection process (step S1005) in Embodiment 5 is the same as the method explained using FIGS. 5 and 6 in Embodiment 1 or the method explained using FIGS. 7 and 8 in Embodiment 2.

FIG. 18 is a flowchart showing the storage process (2400) procedure of the region soundness inspection result information, which is to be performed before ejection of the optical disk medium in Embodiment 5.

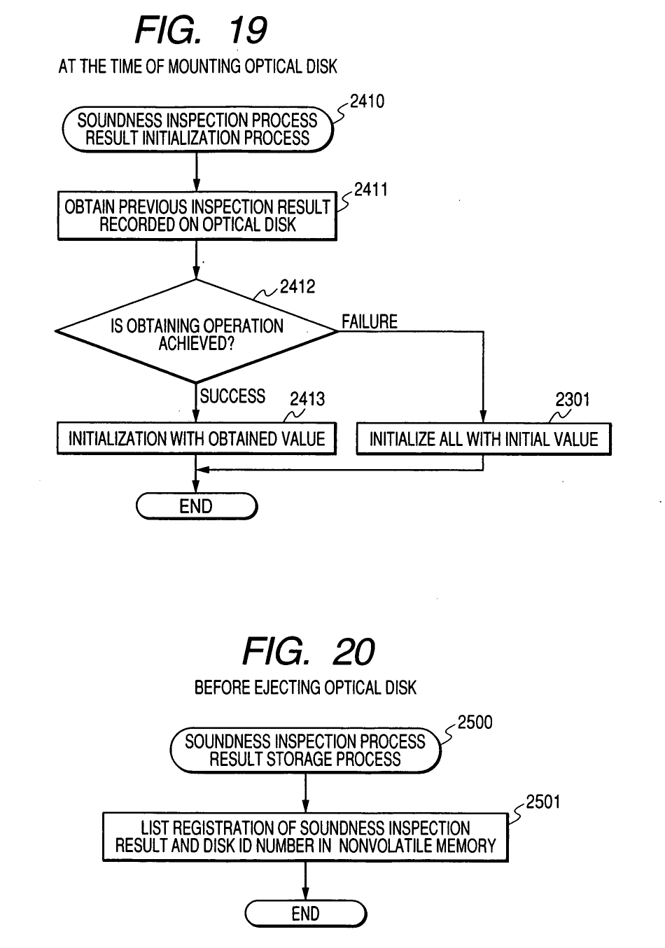

FIG. 19 is a flowchart showing the initialization process (2410) procedure of the region soundness inspection result information.

In Embodiment 5, upon receiving an optical disk medium ejection request from a higher-level device, a process is performed to record the region soundness inspection result information which is obtained before the reception of the ejection request in the management information region 4 of the optical disk medium 1 as shown in FIG. 18 (step S2401) and the optical disk medium 1 is ejected after this recording.

When the same optical disk medium 1 is mounted next time, the soundness inspection result information which is recorded before ejection of the optical disk medium 1 is read as shown in FIG. 19 (step S2411), and when the reading operation is achieved (step S2412), the soundness inspection result information is initialized using the obtained value (step S2413). When the reading operation fails or when there is a problem in the obtained value, the initialization using an initial value is performed as explained using FIG. 17 in Embodiment 1 (step S2301).

With the processes mentioned above, by utilizing the region soundness inspection result information which is obtained when the same optical disk medium 1 is mounted as the last time, the region soundness inspection process may be omitted or regions for which region soundness inspection result information is uncertain may be decreased, so that effective recording region allocation can be performed.

It should be noted that only one of the process for recording the soundness inspection result information in the optical disk medium 1 explained using FIG. 18 and the process for reading the soundness information stored in the optical disk medium 1 explained using FIG. 19 may be implemented.

### Embodiment 6

An optical disk recording control device according to Embodiment 6 is the same as Embodiment 1 in construction and the operations thereof are also the same as those of Embodiment 1.

The flow of a defect management recording process in Embodiment 6 is the same as that explained using FIG. 3 in Embodiment 1, and (1) the idle time recognition process and (3) the defect management recording process are the same as the respective processes (steps S1003, S1006) respectively explained in Embodiment 1.

(2) Region Soundness Inspection Process

The flow of a region soundness inspection process (step S1005) in Embodiment 6 is the same as the method explained using FIGS. 5 and 6 in Embodiment 1 or the method explained using FIGS. 7 and 8 in Embodiment 2.

FIG. 20 is a flowchart showing the information storage process procedure of the region soundness inspection result, which is to be performed before ejection of an optical disk medium 1 in Embodiment 6.

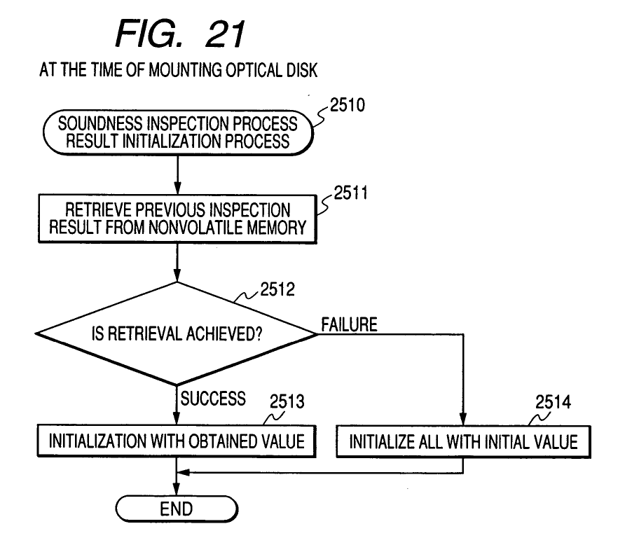

FIG. 21 is a flowchart showing the initialization process procedure of the region soundness inspection result information.

In Embodiment 6, upon receiving an optical disk medium ejection request from a higher-level device, the region soundness inspection result information which is obtained before the reception of the ejection request and the ID number (ID information) of the mounted optical disk medium 1 are stored in the memory 109, which is nonvolatile storing means, in the structure of a list form as shown in FIG. 20. The optical disk medium 1 is ejected after this information storage operation.

When the same optical disk medium 1 is mounted next time, the region soundness inspection result information corresponding to the ID number of the mounted optical disk medium is retrieved from the list of the region soundness inspection result information stored in the nonvolatile memory 109 as shown in FIG. 21 (step S2511). When the corresponding region soundness inspection result information is found by the retrieval, the soundness inspection result information is initialized using the obtained value (step S2513). When the reading operation fails or when there is a problem in the obtained value, the initialization using an initial value is performed as explained using FIG. 17 in Embodiment 1 (step S2301).

With the processes mentioned above, by utilizing the region soundness inspection result information which is obtained when the same optical disk medium 1 is mounted as the last time, the region soundness inspection process may be omitted or regions for which region soundness inspection result information is uncertain may be decreased, so that effective recording region allocation can be performed using the ID number.

With the present invention, by inspecting dirt preliminarily before recording and by referring to the inspection result at the time of recording region allocation, the possibility of a recording failure can be decreased and effective defect management recording can be performed even when there is a scratch or dirt in the recording region on the optical disk medium. The present invention also has an effect of performing an inspection process for a scratch or dirt in the recording region without delaying a request from a higher-level device, which is effective for an optical disk recording control or the like for performing defect management recording for a recording drive compliant with the Mt. Rainier standard of CD-RW, a DVD-RAM recordable drive, a DVD+MRW recordable drive and the like.

1. A disk recording control method for recording data by sectors in a track provided with a concentric or spiral track, comprising:
an idle time recognition step of recognizing a period of time when no access request is made for a disk medium;
a region soundness inspection process step of discriminating a region on the optical disk medium in which normal recording is possible, when the period of time recognized in the idle time recognition step is equal to or longer than a set period of time; and
a region soundness storage step of causing a storage to store information discriminated in the region soundness inspection process step.

2. The disk recording control method according to claim 1, comprising:
a recording step of recording information in the disk medium; and
a replacement step of allocating a replacement region as a recording position on the basis of recognition information stored in the storage, when a recording position on the optical disk medium is discriminated during the recording step as a region in which normal recording is impossible.

3. The disk recording control method according to claim 1, wherein the soundness inspection process step is interrupted in order to attend to an access request, when the access request is made for the optical disk medium during the region soundness inspection process step.

4. The disk recording control method according to claim 1, wherein whether to interrupt the region soundness inspection process step or not is switched over depending on the remaining time before the region soundness inspection process step terminates, when an access request is made for the disk medium during the region soundness inspection process step.

5. A disk recording control method for recording data by sectors in a track provided with a concentric or spiral track, comprising:
an idle time recognition step of recognizing a period of time when no access request is made for a disk medium;
a region soundness inspection process step of discriminating a region on the disk medium which has the possibility of a recording failure, when the period of time recognized in the idle time recognition step is equal to or longer than a set period of time; and
a region soundness storage step of causing a storage to store information discriminated in the region soundness inspection process step.

6. The disk recording control method according to claim 5, comprising:
a recording step of recording information in the disk medium; and
a replacement step of allocating a replacement region as a recording position in ascending order of the possibility of a recording failure on the basis of recognition information stored in the storage, when a recording position on the disk recording medium is recognized during the recording step as a region in which normal recording is impossible.

7. The disk recording control method according to claim 5, comprising:
a recording step of recording information on the disk medium; and
a replacement step of allocating a replacement region as a recording position on the basis of importance of information to be recorded and recognition information stored in the storage, when a recording position on the disk medium is recognized during the recording step as a region in which normal recording is impossible.

8. The disk recording control method according to claim 5, comprising:
a recording step of recording information on the disk medium; and
a replacement step of allocating a replacement region as a recording position on the basis of elapsed time since a start of search of a new replacement region and recognition information stored in the storage, when a recording position on the disk medium is recognized during the recording step as a region in which normal recording is impossible.

9. The disk recording control method according to claim 5, comprising:
a recording step of recording information on the disk medium; and
a replacement step of allocating a replacement region as a recording position depending on a period of time from reception of an executable instruction for the recording step to execution of the recording step.

10. The disk recording control method according to claim 5, comprising:
a recording step of recording information on the disk medium; and
a replacement step of allocating a replacement region as a recording position on the basis of the degree of real-time characteristics of information to be recorded and recognition information stored in the storing means, when a recording position on the disk medium is recognized during the recording step as a region in which normal recording is impossible.

11. The disk recording control method according to any one of claims 5 to 10, wherein the storage for storing information in the region soundness storage step is the optical disk medium.

12. The disk recording control method according to any one of claims 1 to 11, comprising a storage step of storing in nonvolatile storing means soundness information read in the region soundness inspection process step and ID information for identifying a disk medium from which soundness characteristics are read.

13. A disk recording control device for recording data by sectors in a track provided with a concentric or spiral track, comprising:
an idle time recognizer, recognizing a period of time when no access request is made for a disk medium;
a region soundness inspection processor, discriminating a region on the disk medium in which normal recording is possible, when the period of time recognized by the idle time recognizer is equal to or longer than a set period of time; and
a storage, storing information discriminated by the region soundness inspection processor.

14. A disk recording control device for recording data by sectors in a track provided with a concentric or spiral track, comprising:
an idle time recognizer, recognizing a period of time when no access request is made for a disk medium;
a region soundness inspection processor, discriminating a region on the disk medium which has the possibility of recording failure, when the period of time recognized by the idle time recognizer is equal to or longer than a set period of time; and
a storage, storing information discriminated by the region soundness inspection processor.

15. A disk medium, in which information can be recorded, comprising information on the possibility of a recording failure of each recording region of its own.
